(19) United States
(12) Patent Application Publication
(10) Pub. No.: US 2008/0195390 A1
(43) Pub. Date: Aug. 14, 2008

(54) Wireless voice muffled device for mobile communication

(76) Inventor: Irving Almagro, Irvine, CA (US)

Correspondence Address: IRVING ALMAGRO, 2104 SIMPLICITY, IRVINE, CA, 92620, US

(21) Appl. No.: 12/011,128

(22) Filed: Jan. 24, 2008

Related U.S. Application Data
(60) Provisional application No. 60/897,164, filed on Jan. 24, 2007.

(51) Int. Cl. G10L 15/00

(52) U.S. Cl. 704/246

(57) ABSTRACT

A wireless voice muffled device for cellular or mobile phones and voice recognition systems that substantially reduces vocal noise, extra portability and clear intelligible output, said device comprising: a microphone, a transceiver and sound absorbing means. The current invention has three adaptations: handheld, handheld foldable, hands-free and palm-held.

### RELATED APPLICATION

This application claims priority date under 35 U.S.C. section 119(e) from the following U.S. Provisional Application Ser. No. 60/897,164, titled “Wireless voice muffling device,” filed on Jan. 24, 2007.

### BACKGROUND OF THE INVENTION

The present invention relates generally to wireless communications, voice recognition devices, and more particularly to the passive muffling of undesirable extraneous vocal sounds produced when a person talks into an electronic communication device such as cellular, mobile, wireless or wired phone and other devices with microphones. A microphone typically only needs to capture a small percentage of a person's voice for a signal that is suitable for audio processing. Most of the vocal sounds, however, become noise to most people. The operation of cell or mobile phones in places such as restaurants, movie theaters, offices, public transportation settings, etc., has not only become a nuisance to a lot of people but it has also resulted in the loss of the user's privacy.

The Reporting Device that was patented over 20 years ago in Gore, U.S. Pat. No. 4,129,754 provided a viable solution in reducing undesirable sounds when using a microphone in ruckus adverse environments such as courtrooms. A similar product sold by Talk Technologies, Inc. (www.talktech.com), the Sylencer/Stenomask has turned out to be an excellent device for speech recognition systems due to the fact that its microphone when in use is positioned at a constant distance from the speaker's mouth, which is essential in achieving a high rate of recognition success. Birli, et. al, U.S. Pat. No. 7,221,966 provided a device with an imbedded transceiver which facilitated wireless communication from a safety mask.

Bluetooth wireless technology is a short-range communications technology intended to replace the cables connecting portable and/or fixed devices while maintaining high levels of security. WIFI, short for wireless fidelity, is meant to be used generically when referring to any type of 802.11 network, whether 802.11b, 802.11a, dual-band, etc. 3G is an ITU specification for the third generation of mobile communications technology. 3G promises increased bandwidth, up to 384 Kbps. WiMAX, a specification based on the Air Interface Standard, IEEE 802.16 for fixed broadband wireless metropolitan access networks (MANs) provides long range telecommunications for portable devices. WIBREE technology complements close range communication with Bluetooth like performance within 0-10 m range and data rate of 1 Mbps and is optimized for applications requiring extremely low power consumption, small size and low cost. Wireless USB technology facilitates the telecommunications of voice and data signals to computer systems. UHF, VHF, microwave and other radio transceiver technologies convert and reproduce audio and digital signals into radio waves to facilitate telecommunications.

Thus, embedding a Bluetooth, WIFI, WiMAX, Wireless USB or other wireless RF transceiver inside an assembly such as the Stenomask would provide someone speaking into a microphone an effective vocal noise muffling and voice recognition capability.

### OBJECTS OF THE INVENTION

It is therefore an object of the invention to provide a device that can substantially muffle unwanted vocal sounds from people speaking into a microphone and can utilize the Bluetooth or similar wireless systems in conveying the audio signals to telecommunications devices such as cellular, mobile, PBX, Voice Over IP, thereby eliminating cords or cables which can entangle and interfere with the operator's movements.

A further object of the invention is to provide a wireless voice muffler that can effectively eliminate unwanted sounds by incorporating an inner housing or baffle component.

A further object of the invention is to provide a wireless voice muffler for users who need to use a mobile or cell phone in places such as restaurants, sports events, public transportation and formal venues.

A further object of the invention is to provide a wireless voice muffler for office employees who need privacy when conversing on the phone while also reducing the noise nuisance and distraction in their workplace, benefiting employers.

A further object of the invention is to provide a wireless voice muffler for musically inclined and aspiring singers who wish to practice singing while in relatively public environments.

A further object of the invention is to provide a wireless voice muffler for use inside airplane cabins, buses, trains or other transportation systems for passengers who do not like noise or noisy conversations from other passengers seated or positioned nearby.

A further object of the invention is to provide a wireless voice muffler that effectively blocks unwanted sounds therein providing a clear and consistent audio output that can be fed to a speech or voice processing system to perform functions such as voice to word, text processing, language translation and other audio processing applications.

A further object of the invention is to provide a wireless muffler that can interface with Personal Computers.

A further object of the invention is to provide a wireless voice muffler that can easily be cleaned and sanitized.

A further object of the invention is to provide a wireless voice muffler that can be folded allowing it to be easily carried by the user.

A further object of the invention is to provide a wireless voice muffler that can be attached to a lanyard for easy transportability allowing for a hands-free capability.

A further object of the invention is to provide a wireless voice muffler attached to a headband frame by means of hinges, slides or similar mechanical contraptions allowing for a hands-free operation.

A further object of the invention is to provide a wireless voice muffler that can be held inside a person's palm for privately transmitting voice signals.

### SUMMARY OF THE INVENTION

In one exemplary embodiment, the present invention solves the prior art problem of voice mufflers with wires to connect to voice processors by embedding the microphone with a wireless transceiver inside a soundproofed mouthpiece, thereby eliminating the need for a cable or cord tethered to voice muffling devices. Said microphone and transceiver combination can be paired and linked with a cellular phone, a remote computer or server, or other wireless voice processors.

According to another exemplary embodiment of the present invention, a pocket-sized foldable adaptation would provided the user more portability of the present invention.

According to another exemplary embodiment of the present invention an adjustable headband frame attached to the present invention with a hinge would provide more convenience and ease of use.

### BRIEF DESCRIPTION OF THE DRAWINGS

FIG. 1 is the top plan view of the basic handheld embodiment of the invention.

FIG. 2 is the bottom elevational view of the basic handheld embodiment of the invention.

FIG. 3 is the top plan sectional view of the basic handheld embodiment of the invention.

FIG. 4 is the side elevational sectional view of the basic handheld embodiment of the invention.

FIG. 5 is the front elevational perspective view of the basic handheld embodiment of the invention.

FIG. 6 is a pictorial representation of how a person would typically use the basic handheld embodiment of the invention.

FIG. 7 is the top plan view shown in the closed position of a foldable embodiment of the handheld invention wherein two outer hollow shells are hinged together.

FIG. 8 is the top plan view shown in the open position of a foldable embodiment of the handheld invention wherein two outer hollow shells are hinged together.

FIG. 9 is the side sectional view shown in the closed position of a foldable embodiment of the handheld invention wherein two outer hollow shells are hinged together.

FIG. 10 is the perspective view shown in the open position of a foldable embodiment of the handheld invention wherein two outer hollow shells are hinged together.

FIG. 11 is a pictorial representation of how a person would typically use the foldable embodiment of the handheld invention wherein two outer hollow shells are hinged together.

FIG. 12 is the side view shown in the closed position of a hands-free embodiment of the invention with a headband frame support attached to the muffling device using a curved slide.

FIG. 13 is the side view shown in the open position of a hands-free embodiment of the invention with a headband frame support attached to the muffling device using a curved slide.

FIG. 14 is the perspective view shown in the closed position of a hands-free embodiment of the invention.

FIG. 15 is the front view of a palm-held embodiment of the invention.

FIG. 16 is the pictorial representation of a person using a palm-held embodiment of the invention.

FIG. 17 is a diagram of a wireless mouthpiece 10 in accordance with one embodiment of the invention.

FIG. 18 is a diagram of a wireless mouthpiece 10 in accordance with other embodiments of the invention.

### DETAILED DESCRIPTION OF THE PREFERRED EMBODIMENT

As used herein, the term “housing” is intended to generally refer to a metallic or non-metallic or a combination of both, protective cover, casing, case, shell or enclosure designed to contain, enclose or support mechanical, electrical, electronic components, and/or any combination thereof. It can be homogeneous, heterogeneous, multi-layered, multi-bodied, multi-frame, multi-colored and/or any combination thereof.

As used herein, the term “ergonomically shaped” is intended to generally refer to a contoured mass or body that conforms or fits a user's full hand comfortably, does not slip out of the user's hand easily, providing the user the optimum grip with the least amount of effort, to help reduce fatigue and awkwardness. It is also intended that the ergonomically shaped mass' surface be enhanced by integrating a replaceable or non-replaceable, non-slip natural fit compressible gripping material made of wood, rubber, plastic or leather. Another intended enhanced feature is for a flatter and somewhat wider bottom for the ergonomically shaped housing. Further, another intended enhancement for the ergonomically shaped mass is the addition of a quick attach/detach/release hook or strap made of elastic, cloth, plastic or Velcro tape, connected to the mass which wraps around the user's hand to hold the mass in place. A magnetic clasp attached to the strap is also a preferred holding solution. Exemplary ergonomically shaped devices can be found in generic (right-handed or left-handed) PC mouses such as the Logitech MX Laser and Microsoft Wheel Mouse. The exemplary Evoluent VerticalMouse 2 mouse have devices made specifically for either right-handed users or left-handed users.

As used herein, the term “switch” is intended to generally refer to a push button switch. This term has recently been widely adopted by most Bluetooth wireless headset manufacturers. Said switch provides the power up, pairing, microphone activation, power down, as well as other special cellphone wireless headset functions. This switch in most instances has an imbedded small indicator lamps which provide the status information of the headset.

As used herein, the term “transceiver” is intended to generally mean an electronic device or circuit that transmits and receives analog or digital signals. It comes in many forms; for example, a transponder on a satellite, a network adapter in the computer or the circuits in a cellphone. (www.pcmag.com/encyclopedia_term/0,2542,t=transceiver&i=53081,00.asp). One example is the Bluetooth transceiver unit which typically consists of electronic circuits such as codecs, audio to digital converters, digital to audio converters, RF and AF amplifiers, flash memory or ROM, internal memory or RAM, RISC or CPU, automatic shut-off timer, self-test circuitry, and other associated electronic components. Further, the term “module”, refer to a self-contained assembly of electronic components and circuitry, such as a stage in a computer, that is installed as a unit. (www.thefreedictionary.com/module). Therefore, as used herein, the term “transceiver unit or transceiver module,” is intended, but not limited, to generally refer to an integrated assembly having electronic components and circuitry such as a transmitter, receiver, antenna, voice processing, voice conditioning, voice recognition, sound quality optimization, power supply, battery, digital and analog processors, signal conditioners and/or any combination thereof. It should be further understood that it is a common practice in the electronics industry to use expansion slots, adapters, sockets, connectors, and/or any combination thereof, with the goal of providing robustness and extensibility by adding enhancements and new functionalities of their hardware products. An example of this is the PC's modem whereby they have now been integrated into the PCs CPU instead of being an external device with its own power supply. Likewise, this paradigm as is plainly evident works true in reverse. Using the aforementioned model, therefore, it should be understood that some of the components of the transceiver module does not have to stay enclosed inside the module to meet the legal definition but rather some components can also be located outside thereof. For example, to lengthen the transceiver's usage, a battery pack can be added, and to extend its range a RF amplifier and longer antenna can be added, externally. Further, due to the rapid advances in the semiconductor industry with regards to miniaturization, it is further understood that more and more discrete components are being integrated and made modular therein. For example, a decade ago, most PC practitioners refer to the CPU as generally consisting of discrete components such as a CPU chip, digital communications controllers, I/O controllers, firmware ROM, timing circuits, cache controller, etc. Nowadays, the CPU refers to all the components in a motherboard that have been integrated so tightly into almost a single module or unit, allowing them to be installed in a new breed of PC called the Mobile Internet Device (MID).

FIG. 1 shows the top plan view of the wireless mouthpiece seen as general reference 10 which has a hollow cup-shaped, preferably with a crush proof rigid outer housing 11, manufactured of plastic lightweight soundproof material that is open on one end and closed on the other with small venting holes 15 located optimally. Attached towards the front opening of housing 11 is a curved flexible, soft, preferably gel-filled, material 12 that conforms to the shape of the user's face providing an effective muffling of vocal sounds. This piece 12 covers the user's mouth, specifically below the nose area, the cheek areas on either side of the mouth and the area of the chin or lower lip below the Vermilion border.

A pushbutton on-off switch 13, preferably waterproofed with an indicator lamp, allows the activation, pairing or deactivation of the Bluetooth or wireless transceiver unit, preferably waterproofed wherein an automatic timer circuit is also included that will deactivate the system after a certain amount of time to conserve battery life.

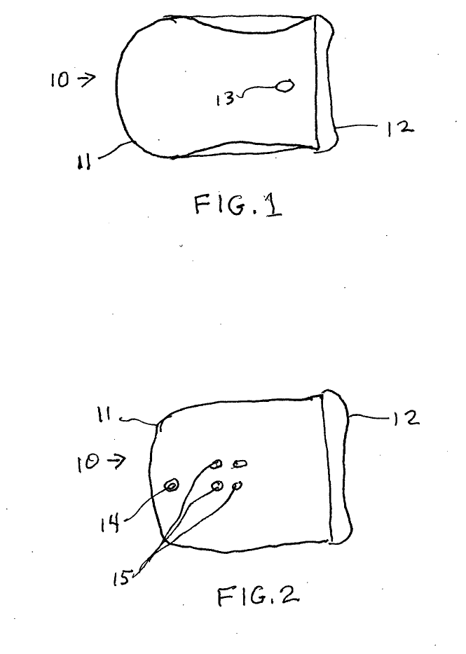

FIG. 2 shows on the bottom of the device an AC adapter socket 14 for connecting an external battery charging unit for the wireless transceiver unit. To reduce an unwanted pressure build-up inside the device during its operation, a plurality of air vents 15 are provided.

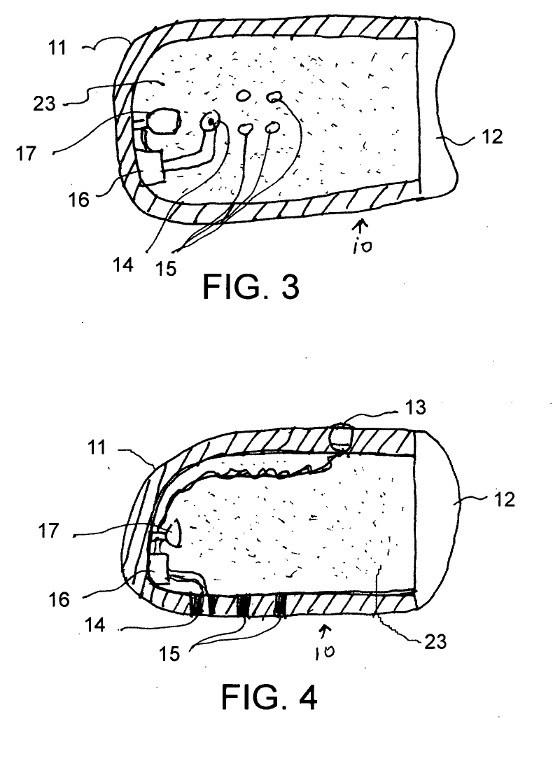

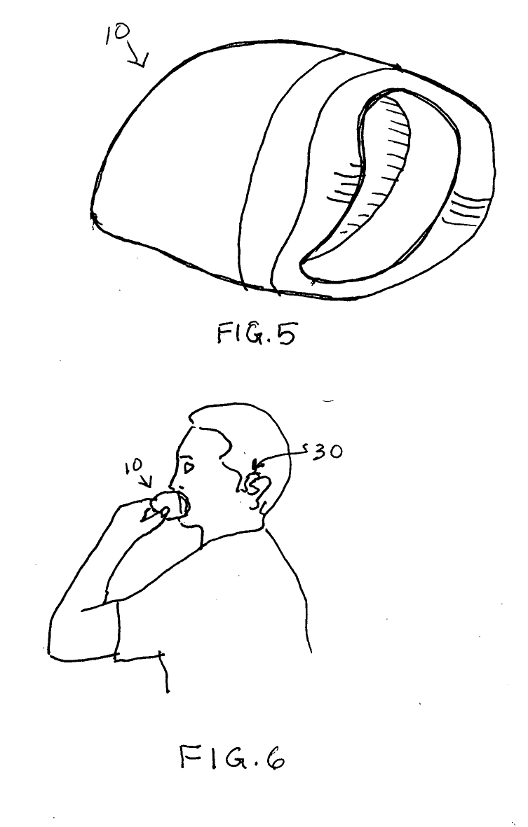

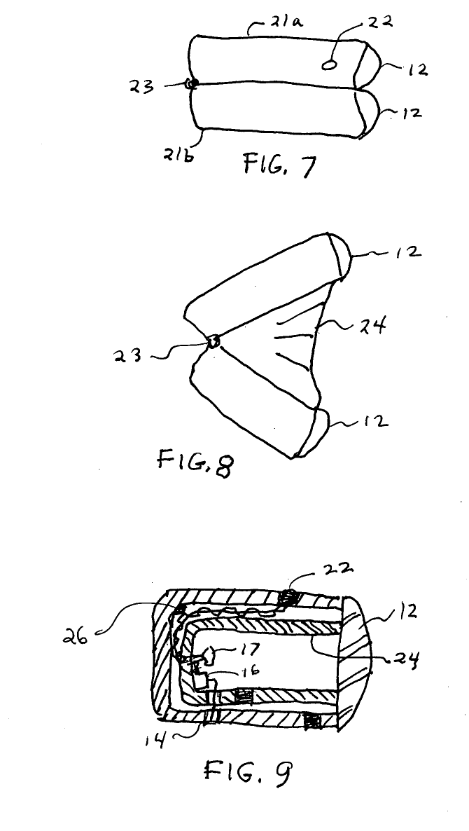

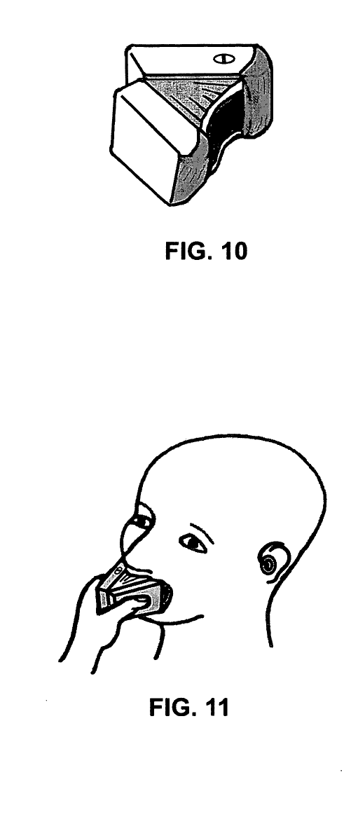

FIG. 3 shows the wireless transceiver module 16 with at least one or more microphones 17, preferably with noise-canceling and waterproof properties connected to it. The number of microphones installed therein will depend on the purpose of the device, e.g., in speech recognition and automated language translation where clarity of the vocal sound is of great importance, two or more optimally positioned microphones will be used. Preferably, anti-bacterial, antiviral or antiseptic foam or disposable liner that is made of waterproof or machine washable sound absorbing material 23, or combinations thereof, is placed inside the rigid housing 10.

FIG. 7 shows a foldable version of the invention 10, composed of two separate preferably hollow crush proof rigid non-metallic soundproof open box-shaped components 21a and 21b, configured to fit a person's hand comfortably and being connected together preferably by a spring hinge 23. Attached towards the front opening of these boxes 21a and 21b are curved flexible, soft, preferably foam or gel-filled material 12 that conforms to the shape of the user's face providing an effective muffling of vocal sounds. These pieces 12 covers the user's mouth, specifically below the nose area, the cheek areas on either side of the mouth and the area of the chin or lower lip below the Vermilion border.

A latch release button 22 preferably located on the top of box 21a wherein if depressed it disengages a hook that fastens the two box components 21a and 21b together, allowing the device to swing open.

FIG. 9 shows an inner formable component 24, preferably made of a flexible material with a soft edge, which is located towards the top and the other at the bottom of the device. Component 24 is triangular shaped that folds in a zigzag pattern similar to an accordion. When the device is in the open position during its normal usage, component 24 gets taut and straightens out to form a secondary housing. In another embodiment of this foldable variance is an inner housing 25 made of a flexible material, preferably embedded or lined with anti-bacterial substances, to facilitate cleaning and sanitation.

A normally closed pushbutton switch 26 located inside the invention wherein it is allowed to toggle “off” causing the microphone circuit to be disabled when the device is closed and toggle “on” when the device is in the open position.

Another preferred embodiment of the foldable version of the invention 10 is provided wherein the speaker or headphone 42 is on the other side of a hollow rigid housing 40 attached to the main housing 10 preferably using a hinge 41. Internally is a normally closed pushbutton switch 26 which deactivates the microphone of housing 10 and activates the microphone 42 of housing 40 when it is in the open position.

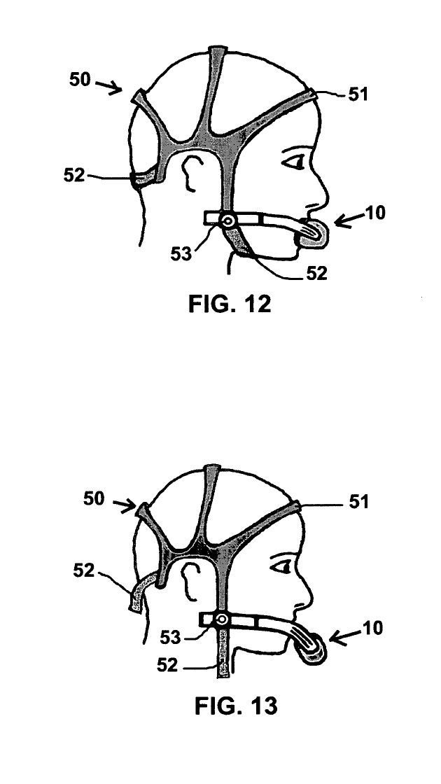

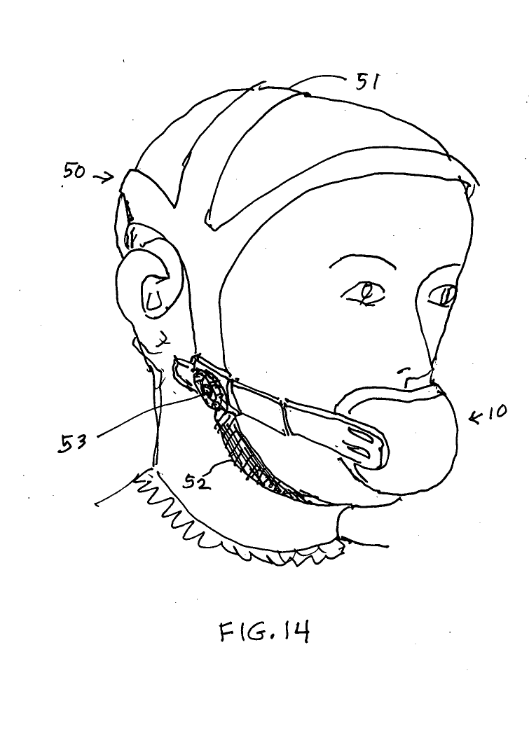

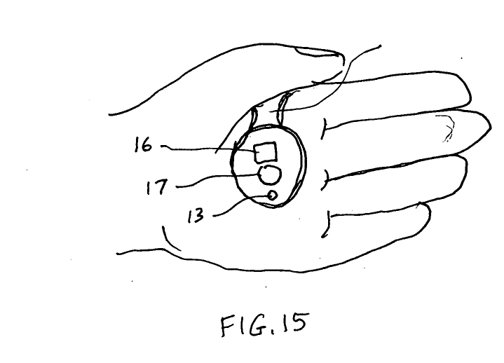

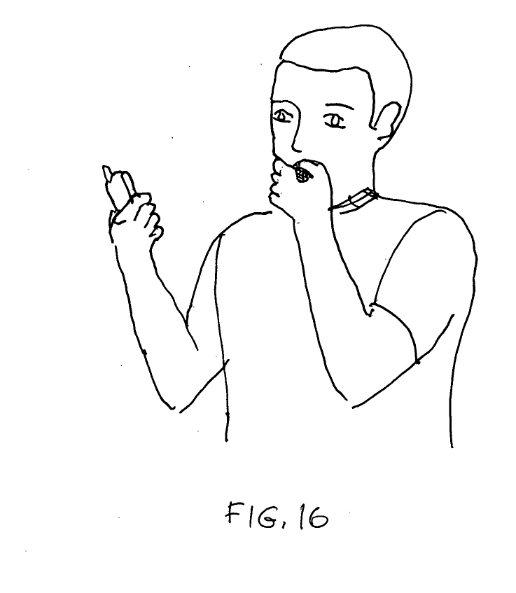

FIGS. 12-13 shows the hands-free muffling headset seen as general reference 50, consisting mainly of a headband frame 51, flexible support arm assembly 51 and the invention 10. The frame 51, preferably foldable and made of either a rigid or semi-rigid and lightweight material, includes a couple of stirrup shaped members. Optimally positioned, these members straddle just behind the ear wherein a soft nylon mesh head strap 52 with Velcro are attached. The main purpose is to provide or improve the headset's stability by adjusting the tightness of the headband to the user's head. The other member is preferably allowed to straddle towards the front of the ear whereby it connects to the adjustable arm support assembly 51. Attached to the bottom of the headband frame 51 is a nylon mesh chinstrap 52 with Velcro, also for the purpose of securing the headgear on the user's head.

The adjustable arm support assembly 53 includes preferably a sliding bracket, a slotted support stay component and an adjustment control on each side of the assembly. Also seen as another embodiment of assembly 53, preferably on each side, is a spring loaded position resilient pivot or hinge spring wherein the microphone muffler is allowed to move slightly inward or outward in order to absorb misalignments during the sliding of the unit up and down the slotted support stay.

FIG. 15 depicts an embodiment of the invention 10 which is a miniaturized version of the handheld wireless voice muffler, wherein the user's palm is used as the main sound barrier. It is preferred that the user uses the whisper intensity instead of using his normal voice when using this invention.

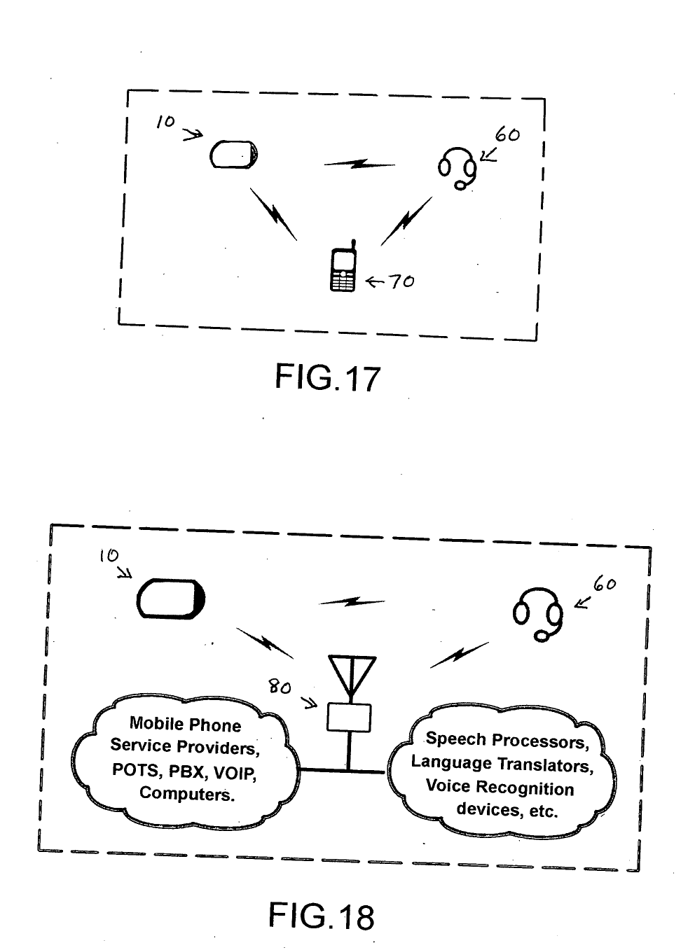

FIG. 17 shows a diagram of a wireless mobile phone 70 communicating with a wireless Base station 80 with a wireless headset 60 and the invention 10.

FIG. 18 shows a diagram of the invention 10 communicating with a wireless headset 60 and a wireless base station transceiver unit 80 that connects to telecommunications devices such as a PC sound card, PC USB dongle, a voice recognition system, an automated language translation system, a reporting or transcription machine or other voice input processors.

I claim:

1. A handheld wireless voice muffling device comprising a housing having a closed end and a wide open end, wherein the closed end of said housing having a contour, ergonomic shape to be grasped and manipulated by the user, wherein the wide open end of said housing having a shape corresponding to the facial area around the mouth of the user thereof whereby said housing further comprising: a microphone; a transceiver; a germicidal or sound absorbing or sound reducing, means or combinations thereof; a switch and a vent.

2. The device according to claim 1 wherein said housing further comprising a supple material conforming to the brims of the wide open end units of said housing that is removable or disposable or reusable or machine washable, or combinations thereof.

3. The device according to claim 1 wherein said housing having a means for varying the input or output signals to or from said transceiver or said microphone.

4. The device according to claim 1 further comprising a wireless earphone or wireless earbud associated with said transceiver.

5. The device according to claim 1 wherein said housing having a strap or a hook or a lanyard attached therewith or combinations thereof.

6. The device according to claim 1 further comprising a mechanical switch or sensor or electronic circuitry or electrical circuitry, or combinations thereof, for activating or deactivating said device, said circuitry is generally located in a main body portion or on the brim portion of said housing.

7. The device according to claim 1 wherein said housing having a means for charging or storing, or combinations thereof, for a wireless headset, wireless earphone or wireless earbud.

8. A handheld wireless voice muffling device comprising:
a main or exterior housing comprising a first shell defining a first cavity, a second shell defining a second cavity whereby said second shell being generally the same size and shape as said first shell, and a hinge that joins one edge of said first cavity and one similar edge of said second cavity thereby defining a clamshell, whereby said hinged edges forming the closed end defining the portion to be grasped and manipulated by a user, the opposite ends of said hinged edges forming a wide open end with the wide open end brim having a contour shape and a supple material; said housing further comprising: a supple or formable inner housing having a generally hollow, truncated pyramid or truncated cone shape, with the wide open end brim having a supple material defining a shape corresponding to the facial area around the mouth of a user and a vent to allow pressurized air within said inner housing and said main housing to escape to the outside;
a microphone positioned inside said inner housing;
a transceiver module located within said inner housing or said main housing;
a switch located on said main housing;
and a sound reducing means located within or part of said main housing or said inner housing, or combinations thereof.

9. The handheld foldable device according to claim 8 wherein said main housing further comprising a removable or disposable or reusable or machine washable, or combinations thereof, supple material conforming to the brims of the wide open end units of said main housing.

10. The handheld foldable device according to claim 8 wherein said housing having a means for varying the input or output signals to or from said transceiver or said microphone.

11. The handheld foldable device according to claim 8 further comprising a cordless or corded, headset or earphone or earbud receiver associated with said transceiver.

12. The handheld foldable device according to claim 8 wherein said main housing having a means for charging or storing, or a combination thereof, for a wireless headset, wireless earphone or wireless earbud.

13. The handheld foldable device according to claim 8 further comprising a detection means for detecting an open or closed state of said first shell unit and said second shell unit.

14-19. (canceled)

20. A palm-held wireless voice muffling device comprising a generally small housing having a round or circular or oval or oblong base that is slightly concave shaped wherein the back of said housing conforms to the shape of the user's palm or cupped hand whereby said housing further comprising: a microphone; a transceiver; a switch; a germicidal or antibacterial or sound eliminating or reducing means, or combinations thereof; and a hook or clasp or strap, or combinations thereof.
